(19) United States
(12) Patent Application Publication
(10) Pub. No.: US 2007/0188150 A1
(43) Pub. Date: Aug. 16, 2007

(54) System and method for supervising battery for vehicle

(75) Inventors: Kazuhi Yamaguchi, Kobe (JP); Masato Ishio, Kobe (JP); Shinji Yamashita, Kobe (JP); Shinji Takemoto, Kobe (JP); Shinichiro Takatomi, Kobe (JP)

Correspondence Address: OLIFF & BERRIDGE, PLC, P.O. BOX 19928, ALEXANDRIA, VA, 22320, US

(73) Assignee: FUJITSU TEN LIMITED, KOBE-SHI (JP)

(21) Appl. No.: 11/705,123

(22) Filed: Feb. 12, 2007

(30) Foreign Application Priority Data
Feb. 16, 2006 (JP) 2006-039913

(51) Int. Cl. H02J 7/00

(52) U.S. Cl. 320/136

(57) ABSTRACT

A system for supervising a battery that supplies power to an electrical unit includes a control part that is supplied with power from the battery and executes a predetermined process when abnormal discharge of the battery occurs; an activation part that detects current consumed in the battery when the electrical unit and the control part are in a sleep mode and activates the control part when the activation part detects abnormal discharge that occurs when an amount of the current consumed in the battery exceeds a given threshold value.

### BACKGROUND OF THE INVENTION

1. Field of the Invention

This invention generally relates to a system and a method for supervising a vehicle-use battery.

2. Description of the Related Art

In recent years, an increased number of electrical units or parts mounted on vehicles is used to improve the vehicle security and comfort. This needs an increased amount of power consumption of the battery mounted on the vehicle. Particularly, it is to be noted that dark current always flows even when all of the electrical units of the vehicle are turned OFF. Increased dark current flowing through the vehicle electrical units may deteriorate the battery. Particularly, when a processor or the like that controls the electrical units is faulty to cause abnormal discharge of the battery, it may be difficult to restart the engine.

The following documents disclose techniques to monitor the dark current flowing through the electrical units on the vehicle: Japanese Patent Application Publication No. 2005-14707; and Japanese Patent No. 3526949.

In the state where all the electrical units on the vehicle are OFF (in a sleep mode) in a parked or stopped state, a monitor-use controller (monitor-use ECU (Electronic Control Unit)) is constantly enabled to monitor dark current and determine whether abnormal discharge takes place. Thus, a large amount of power is consumed even in the sleep mode and is likely to deteriorate the battery.

### SUMMARY OF THE INVENTION

The present invention has been made in view of the above-mentioned circumstances and provides a system and a method for supervising a vehicle-use battery in which the above-mentioned drawbacks are eliminated.

A more specific object of the present invention is to provide a system and a method for supervising a vehicle-use battery in which a reduced amount of current is consumed in a control part for supervising a battery in a sleep mode of electrical units in the parked or stopped state and abnormal discharge on an electronic unit can be surely detected.

According to an aspect of the present invention, there is provided a system for supervising a battery that supplies power to an electrical unit, including: a control part that is supplied with power from the battery and executes a predetermined process when abnormal discharge of the battery occurs; and an activation part that detects current consumed in the battery when the electrical unit and the control part are in a sleep mode and activates the control part when the activation part detects abnormal discharge that occurs when an amount of the current consumed in the battery exceeds a given threshold value. With this structure, it is possible to minimize battery power consumed by the control part when the electrical unit is in the sleep mode.

According to another aspect of the present invention, there is provided a system for supervising a battery that supplies power to an electrical unit, comprising a control part that is supplied with power from the battery and executes a predetermined process when abnormal discharge of the battery occurs, the control part including a detecting portion that detects current consumed in the battery when the electrical unit is in a sleep mode, the control part operating at a given frequency when abnormal discharge occurs in which an amount of the current consumed in the battery exceeds a given threshold value and operating at a lowered frequency when no abnormal discharge occurs. With this structure, it is possible to minimize battery power consumed by the control part when the electrical unit is in the sleep mode. Further, the control part is capable of executing a necessary process at the given operating frequency, which may be a normal operating frequency, when the abnormal discharge is detected.

The above systems may be configured so as to further include a switch that selectively connects the battery and the electrical unit, wherein the control part controls the switch to disconnect the battery from the electrical unit when the abnormal discharge is detected. With this structure, it is possible to prevent power from being wastefully consumed during supervising.

The above systems may be configured so that: the battery supplies multiple electrical units with power; and the control part identifies a faulty one of the multiple electrical units in which abnormal discharge occurs on the basis of the amount of the current consumed when the abnormal discharge is detected. The faulty electrical unit can easily be identified from the amount of current.

The above systems may be configured so that: the battery supplies multiple electrical units with power; and the control part identifies a faulty one of the multiple electrical units in which abnormal discharge occurs on the basis of at least a condition of the battery and states of the multiple electrical units. With this structure, the faulty electrical unit can be identified easily and reliably.

The above systems may be configured so that: the battery supplies multiple electrical units with power; and the control part identifies a faulty one of the multiple electrical units in which abnormal discharge occurs by activating a function of detecting abnormal discharge provided in the multiple electrical units. With this structure, the faulty electrical unit can be identified easily and reliably.

The above systems may be configured so that the control part sends first information about the abnormal discharge to a supervisory center through a communication unit when the abnormal discharge is detected and receives second information indicative of a faulty one of multiple electrical units to which the battery supplies power, the faulty one of the multiple electrical units being presumed by the supervisory center on the basis of the first information. With this structure, it is possible to reduce the burden of the control part because the faulty electrical unit is identified on the management center side.

The above systems may be configured so that the control part activates the faulty one of the multiple electrical units presumed and confirms occurrence of the abnormal discharge. It is thus possible to reliably identify the faulty electrical unit.

The above systems may be configured so that the control part saves data in the electrical unit when the abnormal discharge is detected. It is thus possible to prevent data from being lost even when the battery runs out.

The above systems may be configured so that the control part stops supplying power to electrical units except for an electrical unit involved in a security of the vehicle after saving of data is completed or stops supplying power to at least a faulty one of the electrical units. It is thus possible to secure the vehicle security and to simultaneously prevent wasteful battery power consumption.

The above systems may be configured so that the control part stores information about the abnormal discharge in a memory when the abnormal discharge is detected. The information about the abnormal discharge may be indicative of the time when the abnormal discharge occurred, the amount of current, and the type of the faulty electrical unit. It is thus possible to refer to the information stored in the memory and take a necessary step to detect an abnormal position and repair the faulty electrical unit.

The above systems may be configured so that the control part controls the switch to connect the battery to the electrical unit so that the electrical unit is supplied with power again when a predetermined condition is met. It is thus possible to prevent battery power from being wastefully consumed after an abnormality is detected and to prevent the driver from encountering any trouble in driving, for example, when the driver turns ON the ignition switch in order to drive the vehicle again.

The above systems may be configured so that the control part informs a user of occurrence of the abnormal discharge when the abnormal discharge is detected, and controls the switch to shut off a power supply to the electrical unit in response to a shutoff request from the user. It is thus possible for the user to intentionally control power supply and shutoff for the electrical unit, as necessary.

The above systems may be configured so that the control part determines whether a power supply to the electrical unit should be shut off on the basis of the amount of the current consumed in the abnormal discharge and a remaining capacity of the battery when the abnormal discharge is detected. It is thus possible to flexibly cope with the abnormality while maintaining the functions of the electrical unit and power saving.

The above systems may be configured so that the activation part includes a power supply circuit that supplies power to the control part when the abnormal discharge is detected. That is, no power is supplied to the control part, which I thus disabled before the abnormality is detected. Therefore, the control part consumes no battery power unless an abnormality is detected.

According to yet another aspect of the present invention, there is provided a method for supervising a battery that supplies power to an electrical unit mounted on a vehicle, comprising the steps of: detecting current consumed in the battery when the electrical unit and a control part that is supplied with power from the battery and executes a predetermined process when abnormal discharge of the battery occurs are in a sleep mode; and activating the control part when abnormal discharge in which an amount of the current consumed in the battery exceeds a given threshold value takes place.

According to a further aspect of the present invention, there is provided a method for supervising a battery that supplies power to an electrical unit, comprising the steps of: detecting current consumed in the battery when the electrical unit is in a sleep mode; operating a control part, which is supplied with power from the battery and executes a predetermined process when abnormal discharge of the battery occurs, at a given frequency when abnormal discharge occurs in which an amount of the current consumed in the battery exceeds a given threshold value; and operating the control part at a lowered frequency when no abnormal discharge occurs.

### BRIEF DESCRIPTION OF THE DRAWINGS

Other objects, features and advantages of the present invention will become apparent from the following detailed description when read in conjunction with the following accompanying drawings, in which:

FIG. 1 is a block diagram of an electrical system of a vehicle to which a system for supervising a vehicle-use battery is applied in accordance with an embodiment of the present invention;

FIG. 2 is a flowchart of an abnormal discharge detection process executed by a supervisory ECU shown in FIG. 1;

FIG. 3 is a flowchart of an abnormal position identifying process executed by the supervisory ECU;

FIG. 4 shows electrical units and currents respectively consumed therein;

FIG. 5 is a flowchart of a second example of the abnormal position identifying process executed by the supervisory ECU;

FIG. 6 is a flowchart of a third example of the abnormal position identifying process executed by the supervisory ECU;

FIG. 7 is a flowchart of an abnormal position identifying process executed by an ECU built in an electrical unit;

FIG. 8 is a flowchart of a fourth example of the abnormal position identifying process executed by the supervisory ECU;

FIG. 9 is a flowchart of a fifth example of the abnormal position identifying process executed by the supervisory ECU;

FIG. 10 is a flowchart of a post-abnormality-detection process executed by the supervisory ECU;

FIG. 11 is a flowchart of a second example of the post-abnormality-detection process executed by the supervisory ECU;

FIG. 12 is a flowchart of a post-abnormality-detection process executed by the ECU built in the electrical unit;

FIG. 13 is a flowchart of a power supply shutoff process executed by the supervisory ECU;

FIG. 14 is a block diagram of another electrical system to which the system for supervising the vehicle-use battery is applied in accordance with another embodiment;

FIG. 15 is a flowchart of a second embodiment of the power supply shutoff process executed by the supervisory ECU;

FIG. 16 is a flowchart of a third embodiment of the power supply shutoff process executed by the supervisory ECU;

FIG. 17 is a block diagram of yet another electrical system to which the system for supervising the vehicle-use battery is applied in accordance with yet another embodiment;

FIG. 18 is a flowchart of an abnormal discharge detection process executed in the electrical system shown in FIG. 17;

FIG. 19 is a block diagram of a further electrical system to which the system for supervising the vehicle-use battery is applied in accordance with a further embodiment; and

FIG. 20 is a block diagram of a still further electrical system to which the system for supervising the vehicle-use battery is applied in accordance with a still further embodiment.

### DESCRIPTION OF THE PREFERRED EMBODIMENTS

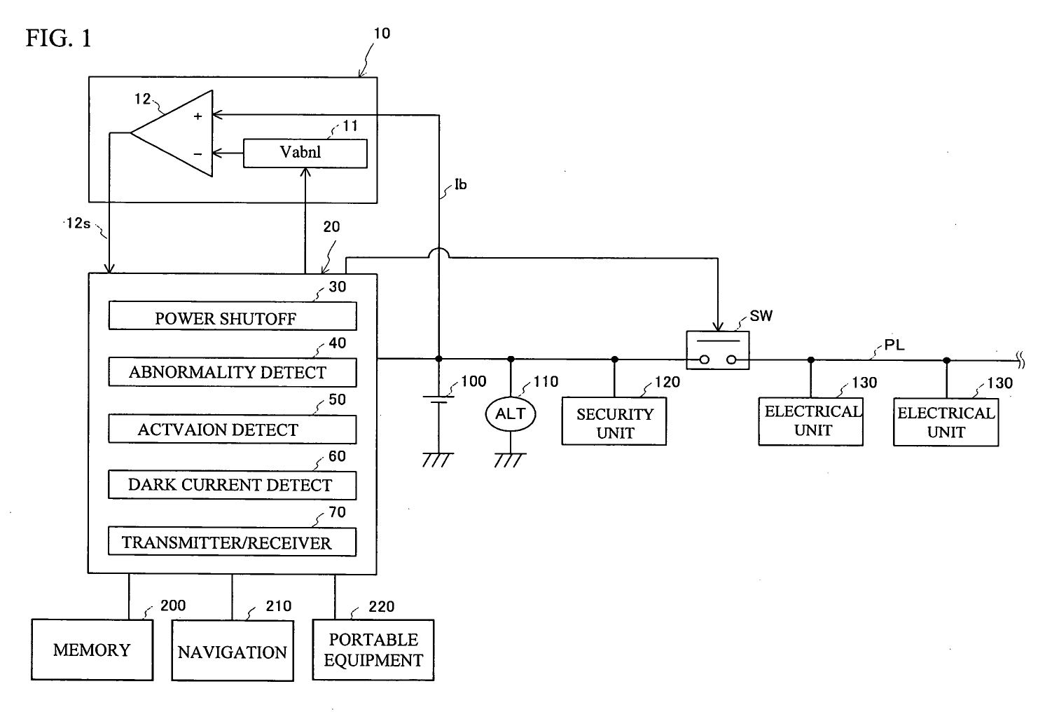

FIG. 1 is a block diagram of an electrical system mounted on a vehicle to which a battery supervising system is applied in accordance with an embodiment of the present invention.

Referring to FIG. 1, the electrical system of the vehicle includes a battery 100, an alternator 110, a supervisory ECU 20 serving as a control part or a controller for supervision, a security unit 120 and multiple electrical units 130. The supervisory ECU 20, the security unit 120, and the other electrical units 130 are connected to the battery 100 through a power supply line PL, and are supplied with electrical power therefrom. The battery supervising system is composed of the supervisory ECU 20 and an abnormal discharge detection circuit 10, which functions as an activation part or an activation unit.

The battery 100 may, for example, be a lead-acid battery and supplies electrical power stored therein to the on-vehicle electrical units. The alternator (ALT) 110 is driven by an engine on the vehicle through a belt (not shown), and generates an alternating output, which is then rectified by a built-in diode. The resultant DC output is supplied to the electrical units 130 including the security unit 120 and is also used to charge the battery 100.

The security unit 120 is an electrical unit related to the vehicle security, and may be an electronic lock system, a keyless entry system or a smart entry system. The security unit 120 is electrically connected to the power supply line PL to which the battery 100 and the alternator 110 are connected, and is supplied with electrical power.

The multiple electrical units 130 may be a starter, a winker, a headlight, or a switch, and may be a control system such as a fuel injection system or an antilock brake system. The multiple electrical units 130 are supplied with electrical power via the power supply line PL. The security unit 120 and the multiple electrical units 130 may be equipped with respective controllers (ECU), each of which may include a hardware structure having a processor, a memory and so on and related software. The controllers, or the on-unit ECUs are supplied with electrical power via the power supply line PL and are capable of communicating with the supervisory ECU 20 via a communication line (not shown).

A switch SW is provided on the power supply line PL and is controlled by the supervisory ECU 20. The switch SW connects and disconnects the battery 100 to and from the multiple electrical units 130 in accordance with a control signal supplied by the supervisory ECU 20. It is to be noted that the security unit 120 is constantly supplied with electrical power even when the electrical units 130 are disconnected from the battery 100 due to the function of the switch SW.

The abnormal discharge detection circuit 10 may be composed of an operational amplifier 12 and a threshold value hold circuit 11. The circuit 11 holds a threshold value V_{abnl} for detecting abnormal discharge. The ECU 20 can rewrite the threshold value V_{abnl} in the threshold value hold circuit 11. The operational amplifier 12 receives a consumed current (dark current) of the battery 100 through one of two input terminals, and the threshold value V_{abnl} through the other input terminal. When the security unit 120, the electrical units 130 and the supervisory ECU 20 are in the sleep modes, the operational amplifier 12 compares the consumed current with the threshold value V_{abnl}. If an abnormal discharge that exceeds the threshold value V_{abnl} takes place, the operational amplifier 12 functioning as a comparator supplies the supervisory ECU 20 with an activation signal 12s for activating the supervisory ECU 20. In the sleep modes, the primary functions of the security unit 120, the electrical units 130 and the supervisory ECU 20 are turned OFF in a hardware or software manner. A large amount of power is consumed in the primary functions. Only parts of the functions may be active even in the sleep modes.

The supervisory ECU 20 may be composed of a hardware structure including a processor, a memory and so on, and software. As shown in FIG. 1, the supervisory ECU 20 functionally has a power supply shutoff part 30, an abnormality detection part 40, an activation signal detection part 50, a vehicle dark current detection part 60, and a transmitter/receiver part 70. An external memory 200, a navigation system 210 and portable communication equipment 220 are connected to the supervisory ECU 20.

The power supply shutoff part 30 outputs the control signal to the switch SW when the predetermined condition is satisfied, so that a supply of power to the electrical units 130 from the battery 100 can be shut off. The abnormality detection part 40 detects an abnormality that occurs in any of the electrical units 130. The activation signal detection part 50 detects the activation signal 12s from the abnormal discharge detection circuit 10. The vehicle dark current detection part 60 detects the dark current (consumed current) of the battery 100 when the vehicle is in the parked or stopped state and the electrical units 130 are in the sleep modes. The transmitter/receiver part 70 sends and receives various data to and from the navigation system 210, the portable communication equipment 220, the security unit 120, the electrical units 130 and a supervisory center. The portable communication equipment 220 is used to notify the user of information. The equipment 220 is capable of sending and receiving a variety of information about the vehicle to and from the supervisory center, which will be described later.

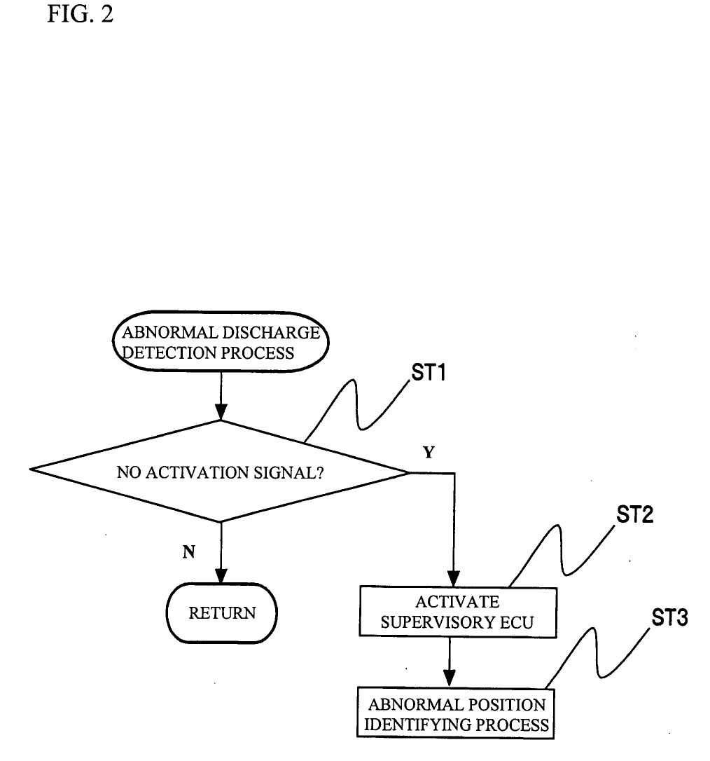

A description will now be given, with reference to flowcharts of FIGS. 2 through 14, of exemplary process sequences of the supervisory ECU 20.

The supervisory ECU 20 repetitively executes an abnormal discharge detecting sequence shown in FIG. 2 when the vehicle is in the parked or stopped state in which the supervisory ECU 20 is in the sleep mode.

Referring to FIG. 2, the supervisory ECU 20 determines whether the activation signal 12s from the abnormal discharge detection circuit 10 is received (step S1). The supervisory ECU 20 stops the sequence, when the activation signal 12s is not received. In contrast, when the activation signal 12s is received, the supervisory ECU 20 activates its own primary function (step ST2), and executes an abnormal position identifying process (step ST3). In the sleep mode of the supervisory ECU 20, the primary function of detecting the presence/absence of the activation signal is still active.

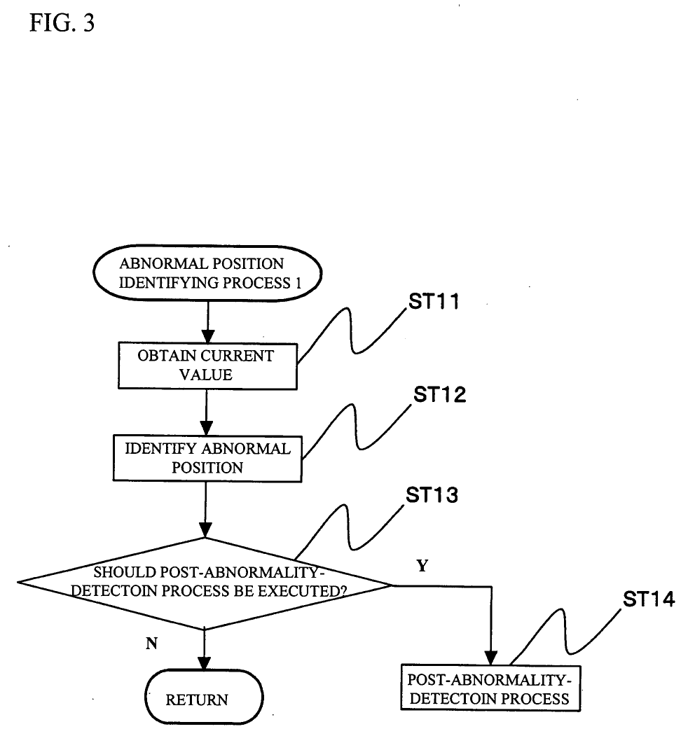

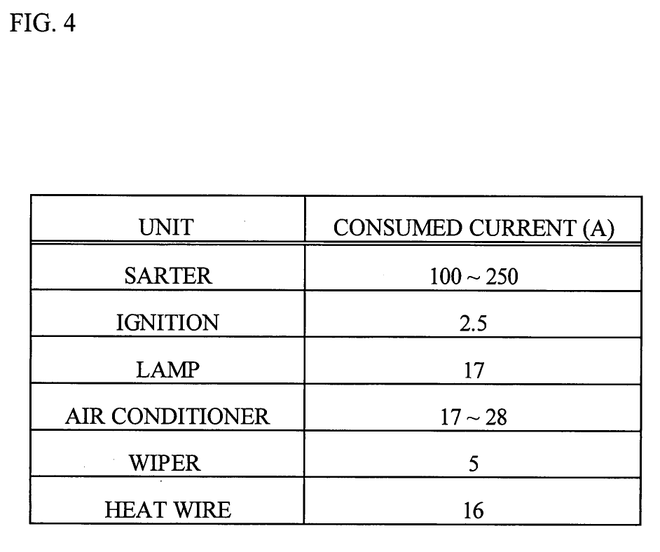

Referring to FIG. 3, the abnormal position identifying process commences to acquire the value of current consumed in the battery 100 (step ST11). Next, the process identifies an abnormal position by referring to the value of current detected (step ST12). An abnormal position may be identified in a manner as shown in FIG. 4. The values of current consumed in the electrical units to be supervised are measured and registered beforehand. It is determined which one of the registered current values is closest to the current value obtained at step ST11. For example, when the current value obtained at step ST11 is 120 A, it is determined that an abnormality takes place in the starter because the current value obtained at step ST11 is closet to the value of current consumed in the starter. By way of another example, if the current value obtained at step ST11 is 17 A, it is determined that an abnormality occurs in any of the lump and the air conditioner because the current value of 17 A is closet to the current values for the lump and the air conditioner.

Turning to FIG. 3 again, post processing that follows the abnormality detection should be executed (step ST13). When the answer of step ST13 is YES, the post processing is executed (ST14), as will be described later.

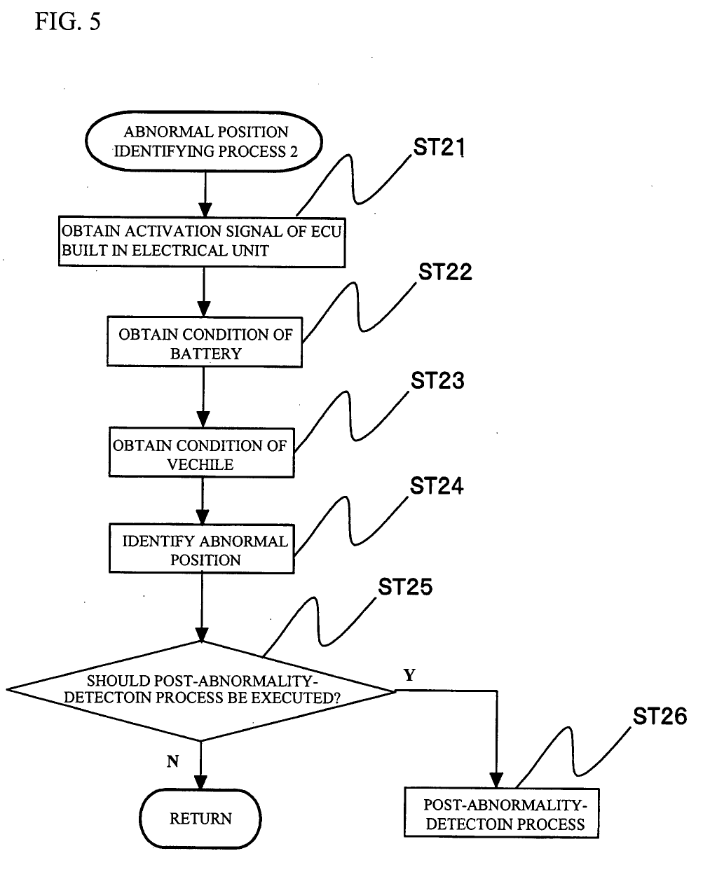

FIG. 5 shows another exemplary abnormal position identifying process. The process commences to obtain the activation signal from the ECU of one of the electrical units 130 (step ST21) in which an abnormality occurs. The ECU of each of the electrical units 130 has the self-activation function that is enabled when detecting an abnormality. The process of step ST21 utilizes the above function of the ECUs of the electrical units 130. Next, the supervisory ECU 20 obtains information about the condition of the battery 100, such as consumed current and voltage (step ST22). Then, the supervisory ECU 20 detects the vehicle condition (step ST23). For example, it is determined whether a person is in the vehicle by referring to information from the smart entry system, or person-sensing information from a camera, sensor or radar.

Then, the supervisory ECU 20 identifies the abnormal position by referring to the condition of the battery 100 and the vehicle condition and determining whether the ECU of the electrical unit 130 that outputs the activation signal is activated due to an abnormality that occurs therein (step ST24). More specifically, when the supervisory ECU 20 determines, by referring to the condition of the battery 100 and the vehicle condition, that the ECU of the electrical unit 130 is activated due to an operation of the driver, the supervisory ECU 20 judges that there is no abnormality. In other cases, the supervisory ECU 20 judges that the electrical unit 130 activated has an abnormality.

Thereafter, the supervisory ECU 20 determines whether post processing that follows abnormality detection (post-abnormality-detection process) should be executed (step ST25). When the answer of step ST25 is YES, the post-abnormality-detection process is executed as will be described later (step ST26). In contrast, when the answer of step ST25 is NO, the supervisory ECU 20 ends the process.

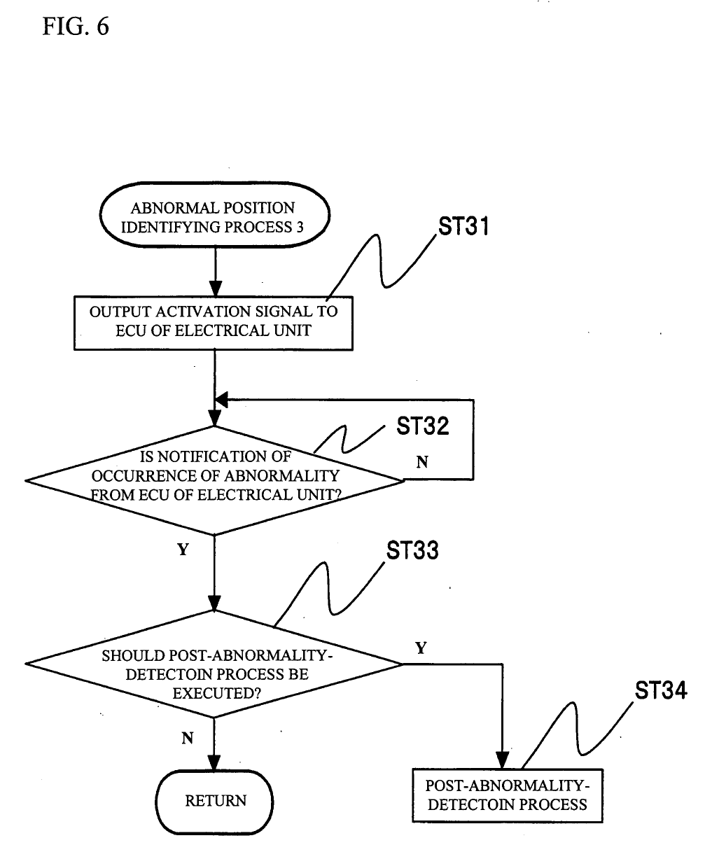

FIG. 6 shows yet another exemplary abnormal position identifying process. Referring to FIG. 6, the supervisory ECU 20 sends the activation signal to each of the electrical units 130 in order to activate the respective on-unit ECUs (step ST31). Next, the supervisory ECU 20 watches a notification of the occurrence of an abnormality that may be generated due to the abnormality detecting function of the ECU of each of the electrical units 130, and identifies the electrical unit 130 in which an abnormality takes place (step ST32). In this manner, the abnormal electrical unit 130 can be identified reliably. Then, the supervisory ECU 20 determines whether the post processing that follows the abnormality detection should be executed (step ST33). When the answer of step ST33 is YES, the post-abnormality-detection process is executed as will be described later (step ST34). In contrast, when the answer of step ST33 is NO, the supervisory ECU 20 ends the process.

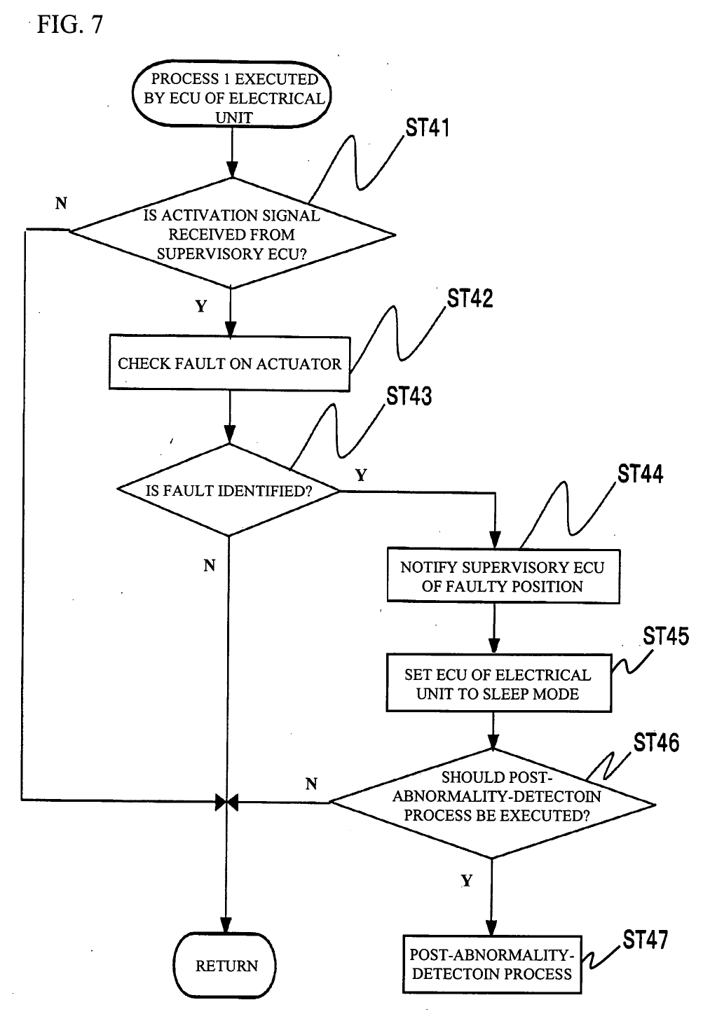

FIG. 7 is a flowchart of a sequence executed by the ECU of the electrical unit 130 in which an abnormality occurs in connection with the abnormal position identifying process executed by the supervisory ECU 20 shown in FIG. 6. The ECU of each electrical unit 130 determines that the activation signal from the supervisory ECU 20 is received (step ST41). The on-unit ECU ends the process in the absence of the activation signal. In contrast, when the activation signal is received, the ECU of the electrical unit 130 carries out a step of determining whether an actuator (for example, a motor) provided in the present electrical unit 130 is faulty (step ST42). This determination may be done by an abnormality detection circuit conventionally provided in the electrical units 130. When it is determined that the actuator does not have any fault (step ST43), the on-unit ECU ends the process. On the contrary, if it is determined that the actuator has a fault, the on-unit ECU notifies the supervisory ECU 20 of the location of the fault (step ST44).

Then, the on-unit ECU, namely, the ECU of the electrical unit 130 spontaneously sets its own mode to the sleep mode (step ST45), and determines whether the post-abnormality-detection process should be executed (step ST46). When the answer of step ST46 is YES, the post-abnormality-detection process is executed as will be described later (step ST47). In contrast, when the answer of step ST46 is NO, the supervisory ECU 20 ends the process.

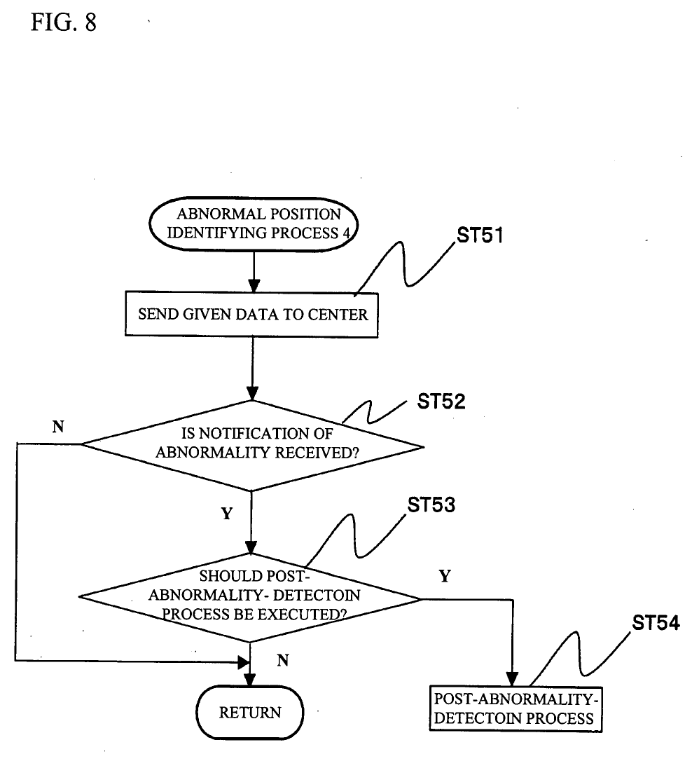

FIG. 8 shows a further exemplary abnormal position identifying process executed by the supervisory ECU 20. Referring to FIG. 8, the supervisory ECU 20 sends given data to a supervisory center using the portable communication equipment 220 (step ST51). The given data may include information about the vehicle condition and the condition of the battery 100 (consumed current). The supervisory center analyzes the given data sent from the vehicle and determines whether an abnormality (fault) occurs. When it is determined that an abnormality (fault) takes place, the supervisory center notifies the supervisory ECU 20 of the occurrence of an abnormality via the transmitter/receiver part 70.

The supervisory ECU 20 determines whether the notification of an abnormality from the supervisory center is received (step ST52). In the absence of the notification, the supervisory ECU 20 ends the process. In contrast, in the presence of the notification of an abnormality, the supervisory ECU 20 determines whether the post-abnormality-detection process should be executed (step ST53). When the answer of step ST53 is YES, the post-abnormality-detection process is executed as will be described later (step ST54). In contrast, when the answer of step ST53 is NO, the supervisory ECU 20 ends the process.

In the above-mentioned manner, the decision as to whether an abnormality takes place is made by the supervisory center, so that the supervisory ECU 20 has a reduced burden of processing.

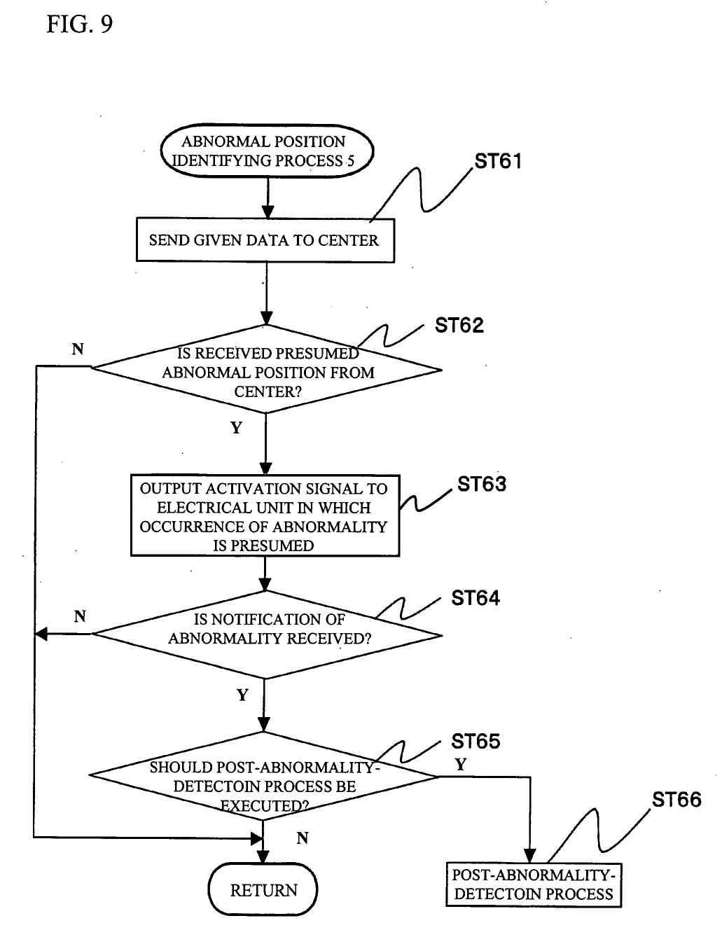

FIG. 9 shows another exemplary abnormal position identifying process involved with the supervisory center. Referring to FIG. 9, the supervisory ECU 20 sends given data to the supervisory center via the transmitter/receiver part 70 as has been described previously (step ST61). The supervisory center analyzes the received data and determines whether there is a presumed abnormal (faulty) position. If a presumed abnormal (faulty) position is identified, the supervisory center notifies the corresponding vehicle of the presence of a presumed abnormal position.

The supervisory ECU 20 determines whether the notification is received from the supervisory center (step ST62). In the absence of the notification, the supervisory ECU 20 judges that there is no abnormality and ends the process. In contrast, if the notification from the supervisory center is received, the supervisory ECU 20 sends the activation signal to the electrical unit 130 in which an abnormality may occur (step ST63). Then, the supervisory ECU 20 determines whether a notification of the occurrence of an abnormality is issued by the involved electrical unit 130 (step ST64). Then, the supervisory ECU 20 determines whether post-abnormality-detection process should be executed (step ST65). When the answer of step ST65 is YES, the post-abnormality-detection process is executed, as will be described later (step ST66). In contrast, when the answer of step ST65 is NO, the supervisory ECU 20 ends the process.

As described above, the supervisory center is asked to presume the position of the occurrence of an abnormality, and only the electrical unit 130 in which the occurrence of an abnormality is presumed is activated to determine whether an abnormality occurs actually. This contributes reduction in the burden of the supervisory ECU 20. In addition, the position of the occurrence of an abnormality can be surely identified while power consumption for abnormality detection is restrained.

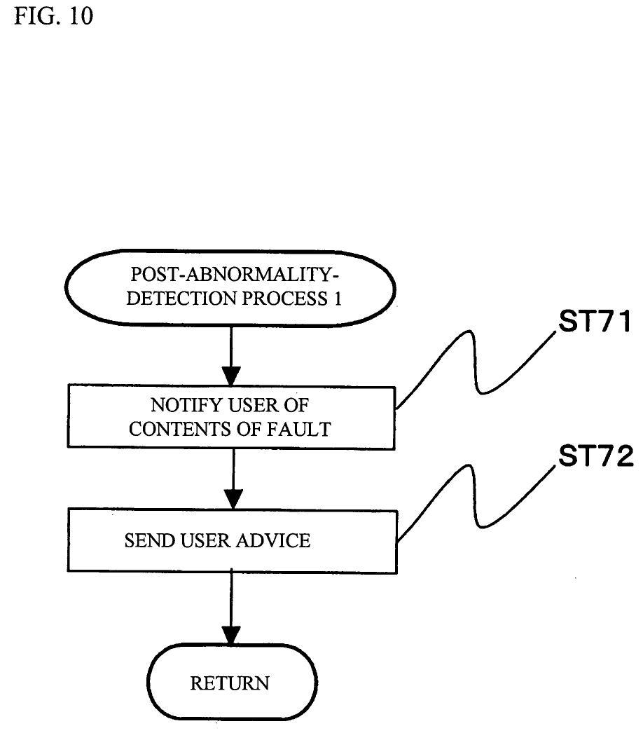

A description will now be given, with reference to FIG. 10, of an example of the post-abnormality-detection process that is executed by the supervisory ECU 20 after an abnormality is detected.

The supervisory ECU 20 notifies the user of the contents of the fault (step ST71). This notification may be implemented by, for example, sending information to user's portable communication equipment or turning ON an indicator. Next, the user is notified of an advice as to how the abnormality (fault) should be handled (step ST72). Then, the supervisory ECU 20 ends the sequence. An exemplary advice says, “Please disconnect the battery terminals”.

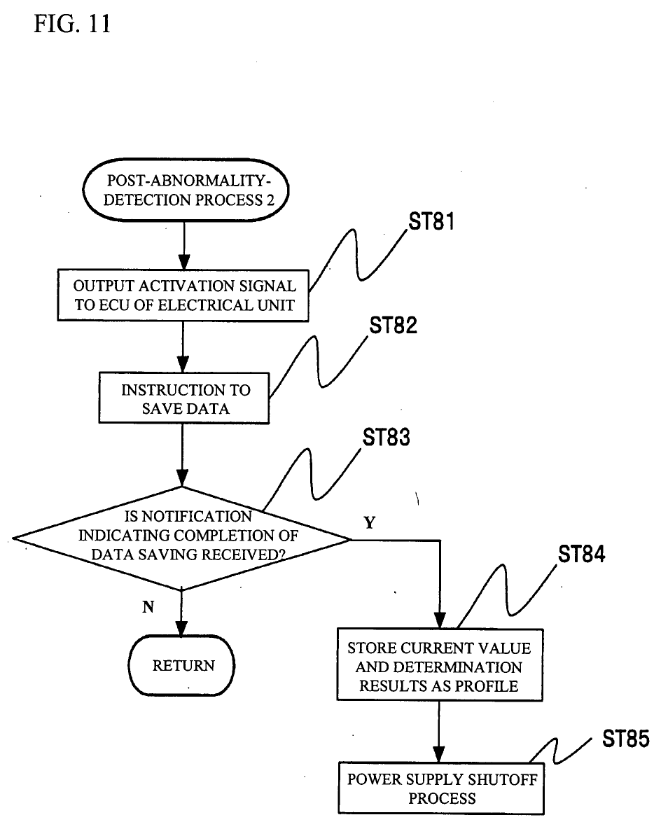

FIG. 11 shows another example of the post-abnormality-detection process executed by the supervisory ECU 20 after the abnormality detection. Referring to FIG. 11, the supervisory ECU 20 sends the activation signal to the ECUs of all the electrical units 130 (step ST81). Next, the supervisory ECU 20 instructs the ECUs of the electrical units 130 to save the related data stored in the volatile memories in non-volatile memories (backup processing) (step ST82). Thus, important data to be saved can be protected from being lost due to deterioration of the battery 100.

Then, the supervisory ECU 20 determines whether notifications indicative of the completion of data saving are received from the ECUs of the electrical units 130 (step ST83). When the notifications are not received, the supervisory ECU 20 ends the process. When the notifications are received, the supervisory ECU 20 stores, in the memory 200 as past history or profile information, information about the abnormality, which may include the detected current value, the results of abnormality determination, and the time when the abnormality occurs (step ST84). The contents of the abnormality can easily be seen from the past history information.

Then, a power supply shutoff process is executed (step ST85), as will be described later.

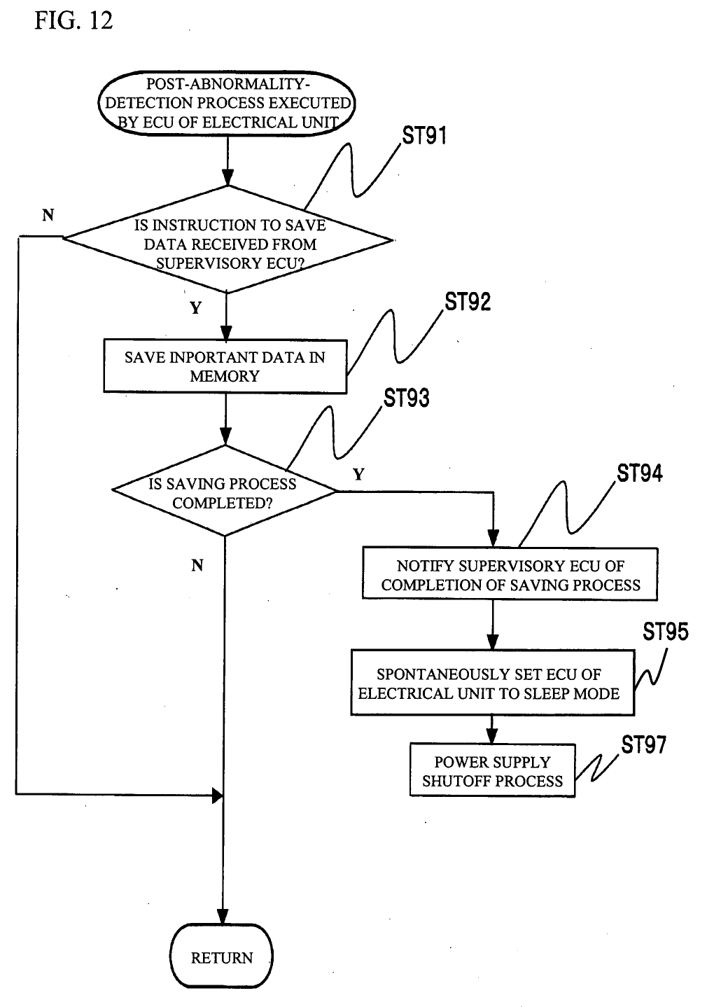

FIG. 12 shows an example of the post-abnormality-detection executed by the ECUs of the electrical units 130. Referring to FIG. 12, the ECUs of the electrical units 130 determine whether to receive an instruction to save the data in the memory 200 issued by the supervisory ECU 20 (step ST91). When the instruction is not received, the ECUs of the electrical units 130 end the process. When the instruction is received, the ECUs of the electrical units 130 save the involved data in built-in non-volatile memories (step ST92). Then, the ECUs of the electrical units 130 determine whether data saving is completed (step ST93). If not, the ECUs of the electrical units 130 end the process. The process of steps ST91 and ST92 will be carried out repeatedly until data saving is completed. In contrast, if data saving is completed, the ECUs of the electrical units 130 inform the supervisory ECU 20 of completion of data saving (step ST94). Then, the ECUs of the electrical units 130 spontaneously set their own modes to the sleep modes (step ST95), and execute the power supply shutoff process, as will be described later (step ST97).

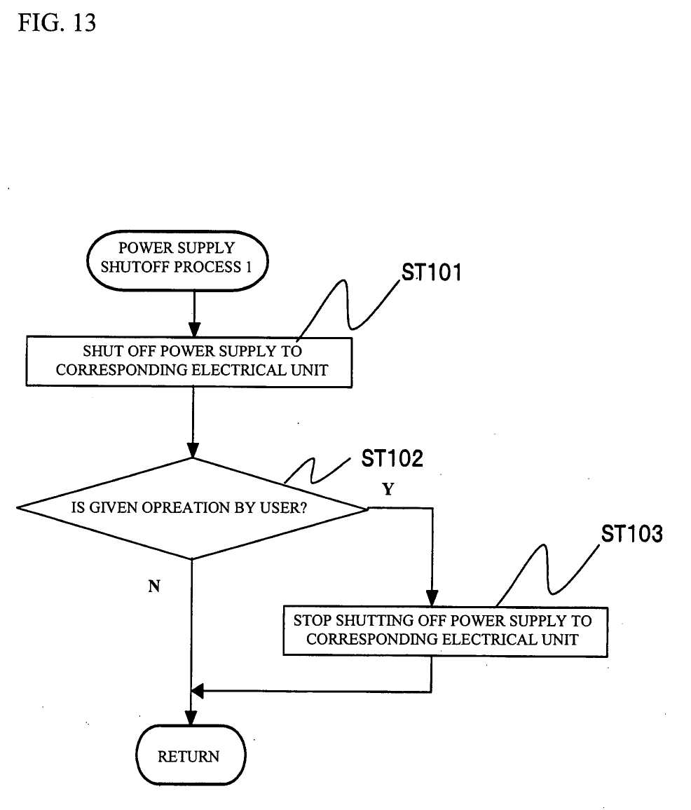

A description will now be given, with reference to FIG. 13, of a first example of the power supply shutoff process executed by the supervisory ECU 20.

First, the supervisory ECU 20 shuts off the power supply to the electrical units 130 (step ST101). More particularly, the supervisory ECU 20 outputs the control signal to the switch SW shown in FIG. 1. The control signal turns OFF the switch SW, which disconnects the electrical unit 130 in which an abnormality occurs from the power supply from the battery 100. This avoids wasteful consumption of power of the battery 100 due to the abnormal discharge. The security unit 120 is continuously supplied with power from the battery 100.

Next, the supervisory ECU 20 determines whether a predetermined operation by the user takes place (step ST102). The predetermined operation may be such that the user opens a door of the vehicle or the driver turns ON the engine ignition switch. When the user's operation does not take place, the supervisory ECU 20 ends the process. In contrast, when the user's operation takes place, the supervisory ECU 20 turns ON the switch SW to supply the electrical units 130 with power again (step ST103). Thus, the electrical units 130 related to the user's operation are enabled.

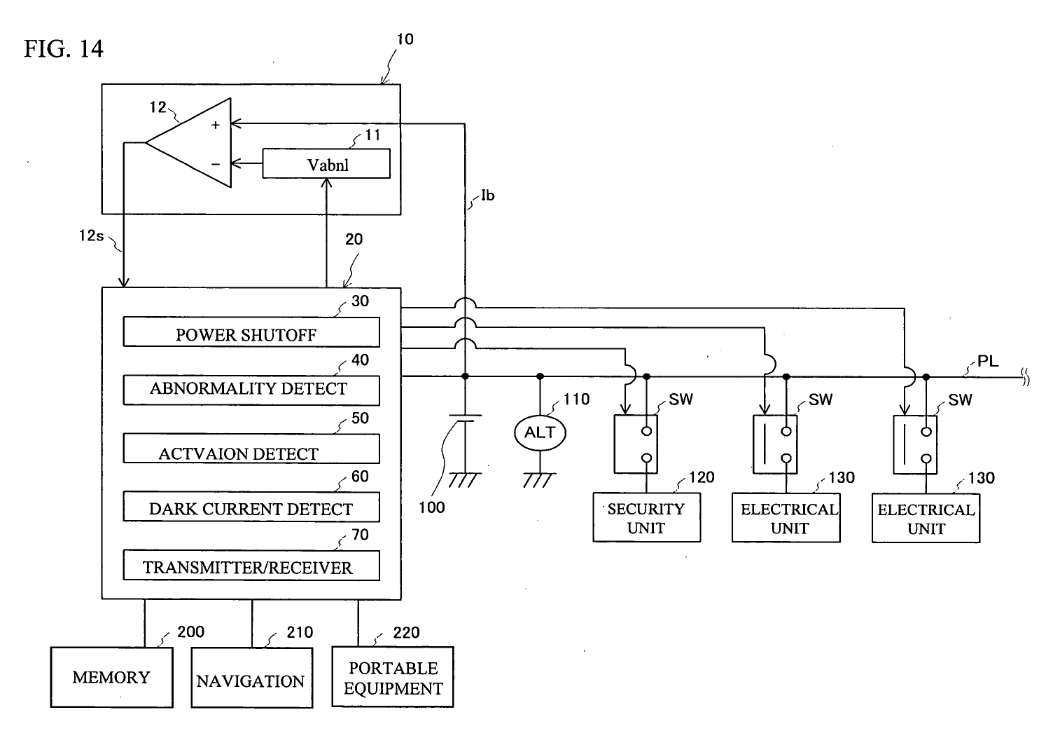

The structure shown in FIG. 1 is so designed that all of the electrical units 130 are disconnected from the power supply when the switch SW is turned OFF. This structure may be modified as shown in FIG. 14 in which each of the electrical units 130 is provided with the respective switch SW and the security unit 120 is provided specifically with the switch SW. It is thus possible to selectively shut off the power supply to the electrical units 130 including the security unit 120 on the unit basis.

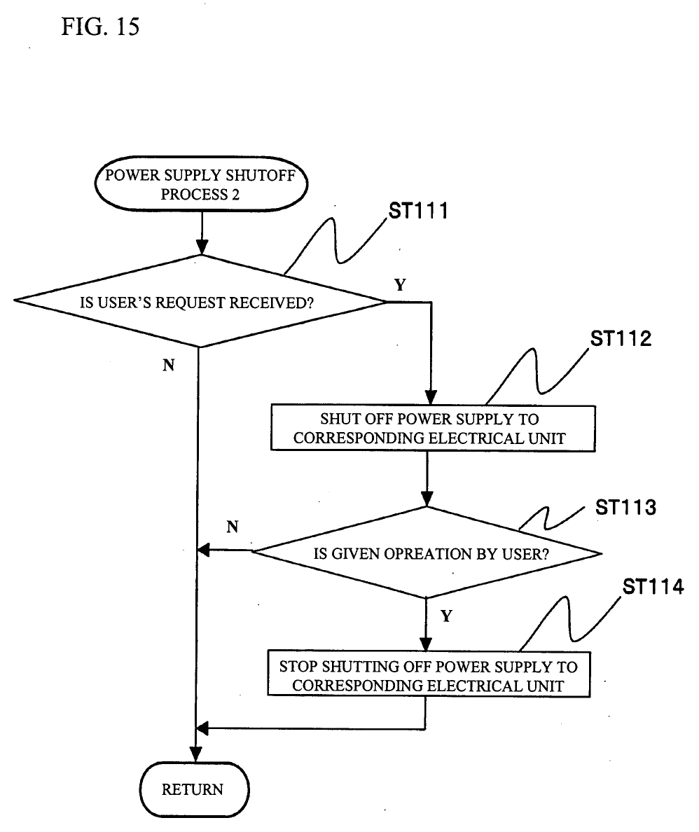

FIG. 15 shows a second example of the power supply shutoff process by the supervisory ECU 20. The supervisory ECU 20 determines whether a power supply shutoff request is input by the user (step ST111). When the request is not input, the supervisory ECU 20 ends the process. In contrast, when the request is input, the supervisory ECU 20 executes power shutoff to the electrical unit 130 related to the user's request (step ST112). Then, the supervisory ECU 20 determines whether the predetermined operation of the user takes place (step ST113). When the answer of step ST113 is NO, the supervisory ECU 20 ends the process. In contrast, when the answer of step ST113 is YES, the supervisory ECU 20 turns ON the switch SW to supply the involved electrical unit 130 with power again (step ST114).

The user can arbitrarily select the electrical unit or units 130 to be shut off.

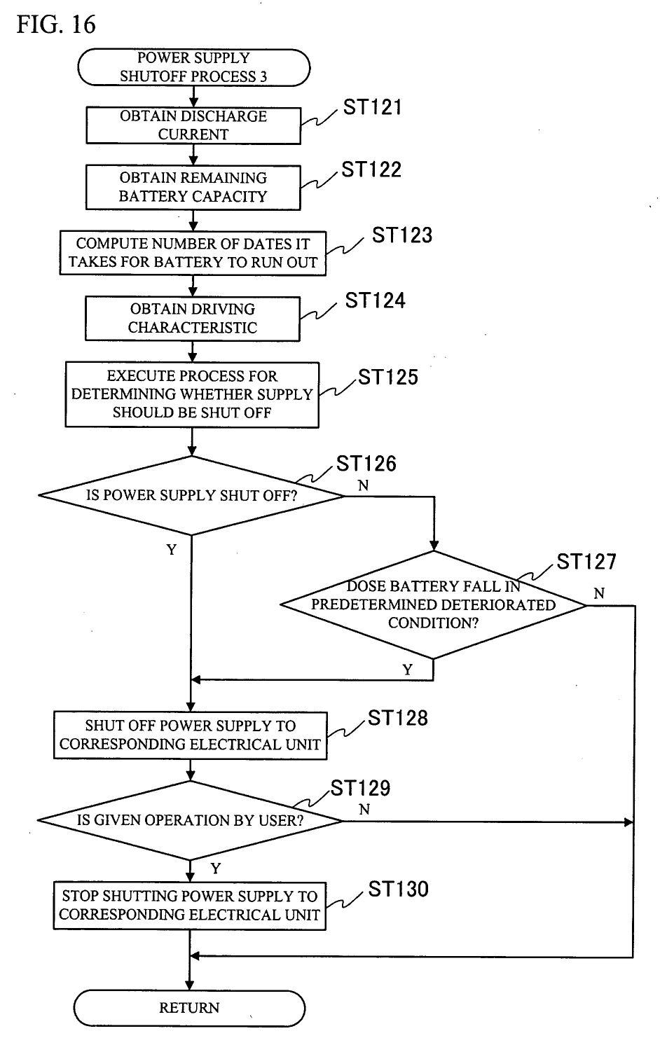

FIG. 16 shows a third example of the power supply shutoff process executed by the supervisory ECU 20. First, the supervisory ECU 20 obtains the discharge current value (step ST121), and obtains the remaining capacity of the battery 100 (step ST122). Then, the supervisory ECU 20 computes the number of dates it takes for the battery 100 to run out on the basis of the discharge current value and the remaining capacity (step ST123). Thereafter, the supervisory ECU 20 obtains a driving characteristic (step ST124). The driving characteristic may include information indicating, for example, how frequently and how long the user drives the vehicle.

An example of the method for computing the number of dates it takes for the battery 100 to run out is now described. The following are assumed for computation: a discharge current value of 1 [A]; a remaining capacity of 90%, a remaining capacity of 30% at which the buttery 100 runs out; and a battery capacity of 55 [Ah]. The following quantity of electricity is available until the battery 100 runs out: 55×3600×0.6=118800 [Asec]. Thus, the time (the number of dates) it takes for the battery 100 to run out is such that 118800 [Asec]/1[A]/3600 [sec]=33 [h]. The supervisory ECU 20 compares the battery usable time (33 [h]) with a presumed vehicle parking time available from the driving characteristic of the user, and determines whether the power supply should be shut off (step ST125).

When the supervisory ECU 20 determines that the power supply shutoff process should be executed, the supervisory ECU 20 stops supplying power to the corresponding electrical unit 130 via the corresponding switch SW (step ST128). Then, the supervisory ECU 20 determines whether the predetermined operation of the user takes place (step ST129) in the same manner as has been previously. When the predetermined operation of the user takes place, the supervisory ECU 20 turns ON the corresponding switch SW and restarts power supply to the electrical unit 130 controlled by the present switch SW (step ST130).

In contrast, when it is determined, at step ST126, that the power supply shutoff process should not be executed, the supervisory ECU 20 determines whether the battery 100 falls in a predetermined deteriorated condition by referring to, for example, the battery voltage and the remaining capacity. When the answer of step ST127 is NO, the supervisory ECU 20 ends the process. In contrast, when it is determined, at step ST127, that the battery 100 falls in the predetermined deteriorated condition, the supervisory ECU 20 carries out the process of the above-mentioned steps ST128 through ST130. It is thus possible to prevent the battery 100 from running out.

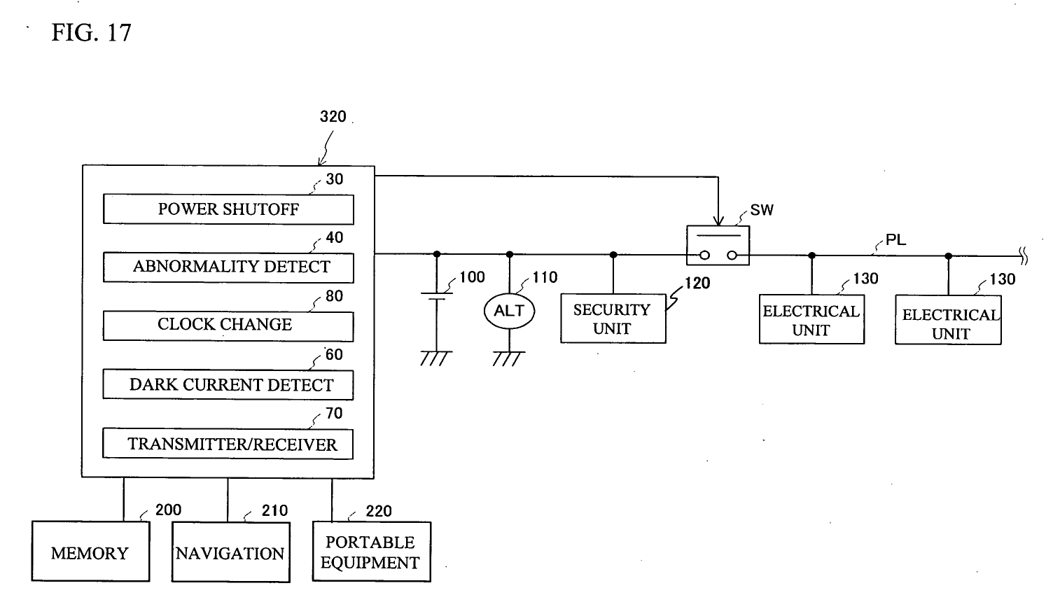

FIG. 17 is a block diagram of yet another example of the electrical system of the vehicle on which the vehicle battery supervising system is mounted in accordance with another aspect of the present invention.

The structure shown in FIG. 17 differs from that shown in FIG. 1 in that the former structure is not equipped with the abnormal discharge detection circuit 10 but a supervisory ECU 320 is equipped with a clock changing part 80 instead of the activation signal detection part 50. The other parts of the structure shown in FIG. 17 are configured as shown in FIG. 1. The clock changing part 80 conditionally changes the operating frequency (clock frequency) at which the supervisory ECU 20 operates, as will be described later.

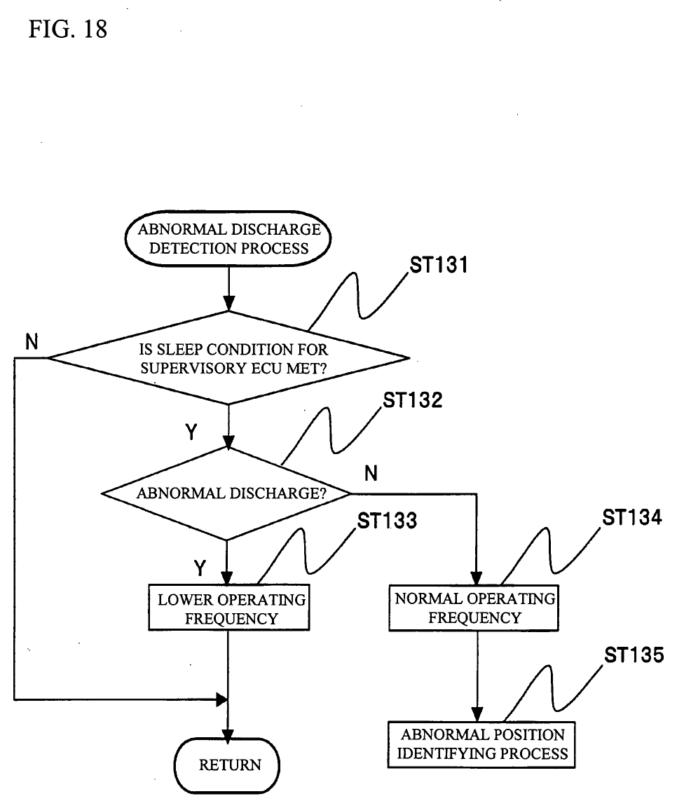

FIG. 18 is a flowchart of an exemplary abnormal discharge detecting process executed by the supervisory ECU 320 shown in FIG. 17. The process shown in FIG. 18 is repetitively carried out during parking or stopping.

The supervisory ECU 320 determines whether the sleep condition is met in the parked or stopped state of the vehicle (step S131). When the answer of step ST131 is YES, the supervisory ECU 320 determines whether abnormal discharge takes place (step ST132). This may be done so that the supervisory ECU 320 detects the current consumed in the battery 100 and compares the consumed current value with the threshold value V_{abnl}. When no abnormal discharge is detected, the clock change part 80 lowers the operating frequency (step ST133). For example, when the normal operating frequency is 80 MHz, the clock changing part 80 changes the operating frequency to a few kHz. This reduces the power consumption of the supervisory ECU 320 greatly, and reduces power consumed in the battery 100. In contrast, if the abnormal discharge is detected at step ST132, the supervisory ECU 320 is caused to operate at the normal operating frequency (step ST134) and executes any of the aforementioned abnormality location identifying sequences (step ST135).

In the present embodiment, when the battery 100 is not good in the parked or stopped state, the supervisory ECU 320 is caused to operate at the normal operating frequency to always monitor the occurrence of an abnormality. When abnormal discharge is not detected, the operating frequency of the supervisory ECU 320 is lowered in order to prevent run out of the battery 100.

The present embodiment may be changed in combination with the aforementioned abnormal discharge detecting process, the abnormal position identifying process or the power supply shutoff process.

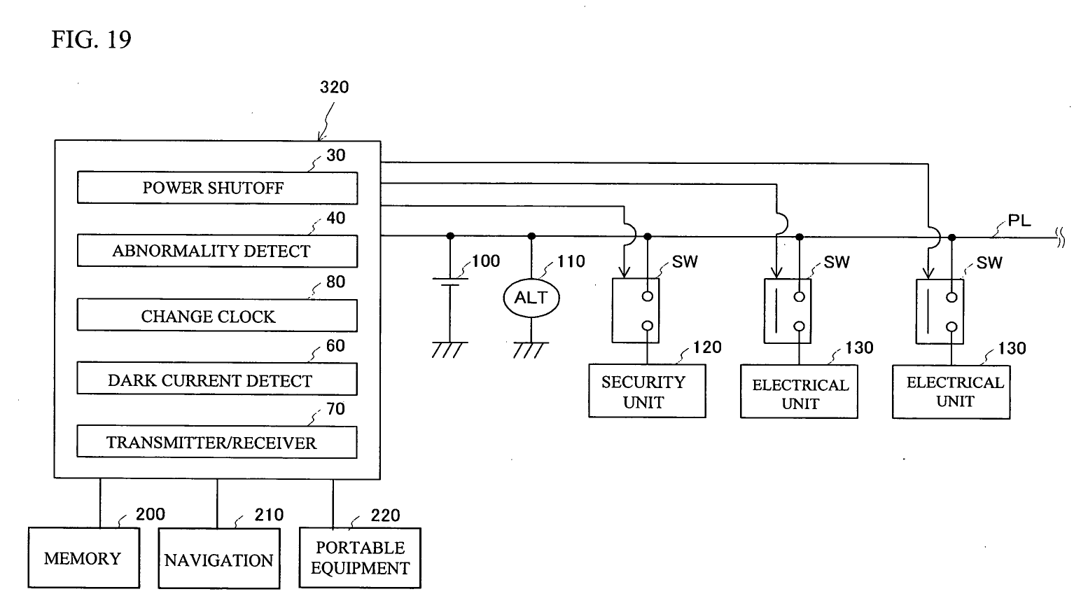

FIG. 19 is a block diagram of a further example of the electrical system of the vehicle to which the vehicle battery supervising system is applied in accordance with an aspect of the present invention. The structure shown in FIG. 19 is a variation of that shown in FIG. 17. The structure shown in FIG. 19 has switches SW, each of which is provided to the respective electrical unit 130 and the security unit 120. The power supply can be shut off for each of the electrical units 130 and the security unit 120.

In the aforementioned embodiments, the supervisory ECU 20 has the function of detecting the presence of the activation signal 12s in the sleep mode. This structure may be changed. For example, the abnormal discharge detecting circuit 10 may be changed so as to have a power supply circuit (power supply IC), so that the supervisory ECU 20 can be stopped totally.

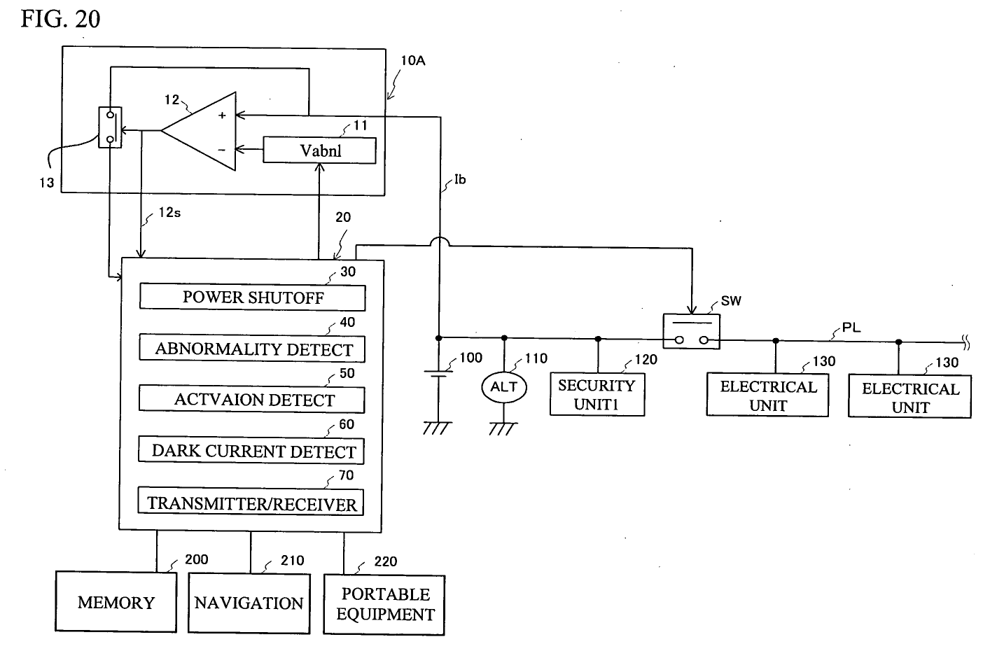

More particularly, as shown in FIG. 20, an abnormal discharge detecting circuit 10A is equipped with a circuit involved with power supply. This circuit is a switch circuit 13 in FIG. 20. The switch circuit 13 is turned ON when receiving the activation signal 12s, so that power from the battery 100 can be supplied to the supervisory ECU 20 through the switch circuit 13. There is not any route for supplying power to the supervisory ECU 20, but only the switch circuit 13 is involved with power supply to the supervisory ECU 20. Thus, the supervisory ECU 20 does not need any power in the normal state but is supplied with power only when the activation signal 12s is generated.

In the foregoing, the supervisory ECU 20 or 320 is specifically provided separate from other ECUs mounted on the vehicle. The functions of the supervisory ECU 20 or 320 may be provided in another ECU such as an engine control ECU.

The system and method for supervising the battery is not limited to the vehicles equipped with internal combustion engines but is applied to electric vehicles or hybrid vehicles.

The present invention is not limited to the specifically disclosed embodiments but may include other embodiments and variations without departing from the scope of the claimed invention.

The present invention is based on Japanese Patent Application No. 2006-039913 filed on Feb. 16, 2006, the entire disclosure of which is hereby incorporated by reference.

What is claimed is:

1. A system for supervising a battery that supplies power to an electrical unit, comprising:
a control part that is supplied with power from the battery and executes a predetermined process when abnormal discharge of the battery occurs; and
an activation part that detects current consumed in the battery when the electrical unit and the control part are in a sleep mode and activates the control part when the activation part detects abnormal discharge that occurs when an amount of the current consumed in the battery exceeds a given threshold value.

2. A system for supervising a battery that supplies power to an electrical unit, comprising a control part that is supplied with power from the battery and executes a predetermined process when abnormal discharge of the battery occurs,
the control part including a detecting portion that detects current consumed in the battery when the electrical unit is in a sleep mode,
the control part operating at a given frequency when abnormal discharge occurs in which an amount of the current consumed in the battery exceeds a given threshold value and operating at a lowered frequency when no abnormal discharge occurs.

3. The system as claimed in claim 1, further comprising a switch that selectively connects the battery and the electrical unit, wherein the control part controls the switch to disconnect the battery from the electrical unit when the abnormal discharge is detected.

4. The system as claimed in claim 1, wherein:
the battery supplies multiple electrical units with power; and
the control part identifies a faulty one of the multiple electrical units in which abnormal discharge occurs on the basis of the amount of the current consumed when the abnormal discharge is detected.

5. The system as claimed in claim 1, wherein:
the battery supplies multiple electrical units with power; and
the control part identifies a faulty one of the multiple electrical units in which abnormal discharge occurs on the basis of at least a condition of the battery and states of the multiple electrical units.

6. The system as claimed in claim 1, wherein:
the battery supplies multiple electrical units with power; and
the control part identifies a faulty one of the multiple electrical units in which abnormal discharge occurs by activating a function of detecting abnormal discharge provided in the multiple electrical units.

7. The system as claimed in claim 1, wherein the control part sends first information about the abnormal discharge to a supervisory center through a communication unit when the abnormal discharge is detected and receives second information indicative of a faulty one of multiple electrical units to which the battery supplies power, the faulty one of the multiple electrical units being presumed by the supervisory center on the basis of the first information.

8. The system as claimed in claim 7, wherein the control part activates the faulty one of the multiple electrical units presumed and confirms occurrence of the abnormal discharge.

9. The system as claimed in claim 1, wherein the control part saves data in the electrical unit when the abnormal discharge is detected.

10. The system as claimed in claim 9, wherein the control part stops supplying power to electrical units except for an electrical unit involved in a security of the vehicle after saving of data is completed or stops supplying power to at least a faulty one of the electrical units.

11. The system as claimed in claim 1, wherein the control part stores information about the abnormal discharge in a memory when the abnormal discharge is detected.

12. The system as claimed in claim 3, wherein the control part controls the switch to connect the battery to the electrical unit so that the electrical unit is supplied with power again when a predetermined condition is met.

13. The system as claimed in claim 3, wherein the control part informs a user of occurrence of the abnormal discharge when the abnormal discharge is detected, and controls the switch to shut off a power supply to the electrical unit in response to a shutoff request from the user.

14. The system as claimed in claim 3, wherein the control part determines whether a power supply to the electrical unit should be shut off on the basis of the amount of the current consumed in the abnormal discharge and a remaining capacity of the battery when the abnormal discharge is detected.

15. The system as claimed in claim 1, wherein the activation part includes a power supply circuit that supplies power to the control part when the abnormal discharge is detected.

16. A method for supervising a battery that supplies power to an electrical unit mounted on a vehicle, comprising the steps of:
detecting current consumed in the battery when the electrical unit and a control part that is supplied with power from the battery and executes a predetermined process when abnormal discharge of the battery occurs are in a sleep mode; and
activating the control part when abnormal discharge in which an amount of the current consumed in the battery exceeds a given threshold value takes place.

17. A method for supervising a battery that supplies power to an electrical unit, comprising the steps of:
detecting current consumed in the battery when the electrical unit is in a sleep mode;
operating a control part, which is supplied with power from the battery and executes a predetermined process when abnormal discharge of the battery occurs, at a given frequency when abnormal discharge occurs in which an amount of the current consumed in the battery exceeds a given threshold value; and
operating the control part at a lowered frequency when no abnormal discharge occurs.
